(19) United States
(12) Patent Application Publication
(10) Pub. No.: US 2012/0054706 A1
(43) Pub. Date: Mar. 1, 2012

(54) Timing analysis method, program and system

(75) Inventor: Susumu Kobayashi, Kanagawa (JP)

(73) Assignee: Renesas Electronics Corporation, Kanagawa (JP)

(21) Appl. No.: 13/137,539

(22) Filed: Aug. 24, 2011

(30) Foreign Application Priority Data
Sep. 1, 2010 (JP) 2010-195399

(51) Int. Cl. G06F 9/455; G06F 17/50

(52) U.S. Cl. 716/113

(57) ABSTRACT

A timing analysis method includes: calculating a delay-voltage function that indicates a relationship between a delay variation rate and voltage variation; calculating a voltage-distance function that indicates a relationship between the voltage variation due to IR drop and a distance; and calculating, by combining the delay-voltage function and the voltage-distance function, a delay-distance function that indicates a relationship between the delay variation rate due to IR drop and the distance. The timing analysis method further includes: correcting, by using the delay-distance function, an OCV coefficient that depends on the distance; and executing a timing analysis of a target circuit by using the post-correction OCV coefficient.

### INCORPORATION BY REFERENCE

This application is based upon and claims the benefit of priority from Japanese patent application No. 2010-195399, filed on Sep. 1, 2010, the disclosure of which is incorporated herein in its entirety by reference.

### BACKGROUND

The present invention relates to a timing analysis of a semiconductor integrated circuit. In particular, the present invention relates to a timing analysis of a semiconductor integrated circuit where influence of IR drop is taken into consideration.

In general, a static timing analysis (STA) is executed as a timing analysis (timing verification) in a designing process for a semiconductor integrated circuit. In the STA, the timing analysis is performed with regard to each signal in a target circuit, by using cell delay values and interconnect delay values stored in a delay file.

Meanwhile, in a manufacturing process for a semiconductor integrated circuit, elements and interconnections may not be manufactured as expected. That is, parameters such as a threshold voltage of a transistor and an interconnect width are likely to vary from desired design values. Such manufacturing variability has influence on delay values within the circuit. It is therefore important to perform the timing analysis with taking the manufacturing variability into consideration at the circuit designing stage.

A correction coefficient called an “OCV (On-Chip Variation) coefficient” is generally used in the STA in order to taking the manufacturing variability into consideration. More specifically, each of the cell delay value and the interconnect delay value stored in the delay file is multiplied by the OCV coefficient to correct each delay value. Then, the post-correction delay value is applied to a target path. This enables the STA where the manufacturing variability is taken into consideration.

In recent years, with speeding up of a semiconductor integrated circuit, influence of a power-supply voltage drop (IR drop) on the circuit delay is getting more considerable. It is therefore desired to execute the timing analysis with taking the influence of the IR drop into consideration.

Patent Literature 1 (Japanese Patent Publication JP-2008-287666) discloses a timing analysis that takes the IR drop into consideration. First, a circuit simulator such as SPICE is used to calculate delay variation due to variation in a power-supply voltage with regard to all cells (functional blocks) used in a target circuit. A correspondence relationship between the calculated delay variation and the variation in the power-supply voltage is provided as a reference table. Next, a power-supply noise analysis of the target circuit is performed and thereby a power-supply voltage waveform of each instance is obtained. Further, a time average of power-supply voltage variation (average voltage variation) is calculated from the power-supply voltage waveform. Subsequently, a delay variation amount regarding each instance is calculated based on the above-mentioned reference table and average voltage variation. Then, the calculated delay variation amount is added to a delay value that is obtained by a timing analysis under a condition of an ideal power-supply voltage. In this manner, a timing analysis result where the IR drop is taken into consideration can be obtained.

### SUMMARY

In the case of the technique described in the Patent Literature 1, it is necessary every time the timing analysis is executed to perform the power-supply noise analysis, calculate the average voltage variation, refer to the reference table and calculate the delay variation amount. This causes increase in a time required for the timing analysis. Since layout modification and the timing analysis are in general performed repeatedly until timing violation is resolved, the increase in the timing analysis time leads to a substantial increase in a design time.

In an aspect of the present invention, a timing analysis method is provided. The timing analysis method includes: (A) calculating a delay-voltage function that indicates a relationship between a delay variation rate and voltage variation; (B) calculating a voltage-distance function that indicates a relationship between the voltage variation due to IR drop and a distance; (C) calculating, by combining the delay-voltage function and the voltage-distance function, a delay-distance function that indicates a relationship between the delay variation rate due to IR drop and the distance; (D) correcting, by using the delay-distance function, an OCV coefficient that depends on the distance; and (E) executing a timing analysis of a target circuit by using the post-correction OCV coefficient.

In another aspect of the present invention, a timing analysis program is provided. The timing analysis program may be recorded on a tangible computer-readable medium. The timing analysis program, when executed, causes a computer to perform timing analysis processing. The timing analysis processing includes: (A) calculating a delay-voltage function that indicates a relationship between a delay variation rate and voltage variation; (B) calculating a voltage-distance function that indicates a relationship between the voltage variation due to IR drop and a distance; (C) calculating, by combining the delay-voltage function and the voltage-distance function, a delay-distance function that indicates a relationship between the delay variation rate due to IR drop and the distance; (D) correcting, by using the delay-distance function, an OCV coefficient that depends on the distance; and (E) executing a timing analysis of a target circuit by using the post-correction OCV coefficient.

In still another aspect of the present invention, a timing analysis system is provided. The timing analysis system has: a delay-voltage function calculation unit configured to calculate a delay-voltage function that indicates a relationship between a delay variation rate and voltage variation; a voltage-distance function calculation unit configured to calculate a voltage-distance function that indicates a relationship between the voltage variation due to IR drop and a distance; a delay-distance function calculation unit configured to calculate, by combining the delay-voltage function and the voltage-distance function, a delay-distance function that indicates a relationship between the delay variation rate due to IR drop and the distance; a table generation unit configured to correct, by using the delay-distance function, an OCV coefficient that depends on the distance; and a timing analysis unit configured to execute a timing analysis of a target circuit by using the post-correction OCV coefficient.

According to the present invention, it is possible to perform a timing analysis of a semiconductor integrated circuit where the influence of the IR drop is taken into consideration. Moreover, increase in a time required for the timing analysis can be suppressed.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a conceptual diagram showing an example of an LOCV table;

FIG. 2 is a conceptual diagram for explaining a typical STA;

FIG. 3 is a conceptual diagram for explaining a summary of the present invention;

FIG. 4 is a flow chart showing a timing analysis method according to a first embodiment of the present invention;

FIG. 5 is a block diagram showing timing analysis processing according to the first embodiment of the present invention;

FIG. 6 is a flow chart showing processing in Step S30;

FIG. 7 is a conceptual diagram for explaining processing in Step S30;

FIG. 8 is a block diagram showing timing analysis processing according to a second embodiment of the present invention;

FIG. 9 is a conceptual diagram for explaining region division processing in the second embodiment; and

FIG. 10 is a block diagram showing a configuration of a timing analysis system according to the embodiments of the present invention.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### 1. Summary

In the static timing analysis (STA), a correction coefficient called the “OCV coefficient” is generally used in order to taking the manufacturing variability into consideration. Each of a cell delay value and an interconnect delay value stored in a delay file is multiplied by the OCV coefficient to correct each delay value. Then, the post-correction delay value is applied to a target path. This enables the STA where the manufacturing variability is taken into consideration.

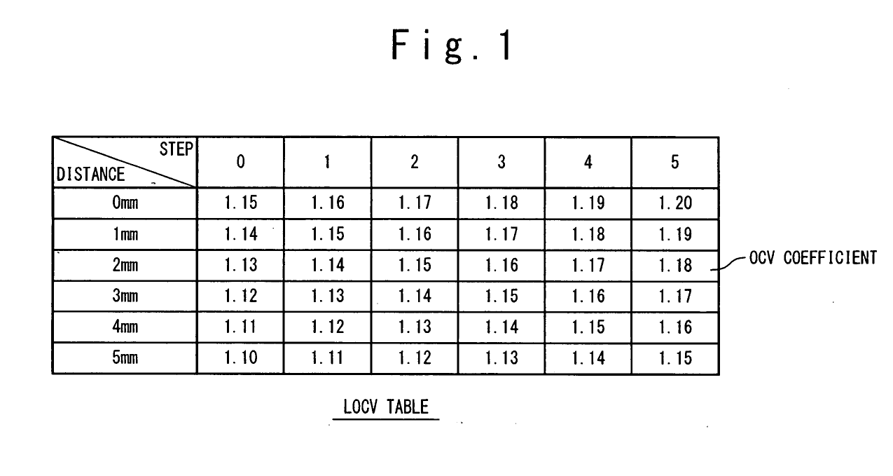

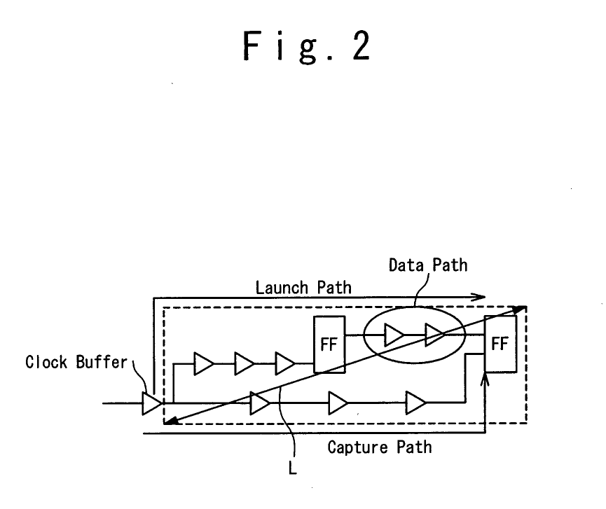

More specifically, the OCV coefficient is prepared for various conditions. The OCV coefficients under the various conditions are typically provided in a table format. The table is called an “LOCV table”. FIG. 1 is a conceptual diagram showing an example of the LOCV table. As shown in FIG. 1, the OCV coefficient depends on “distance” and “logic step” of an analysis target path and is prepared for various combinations of the “distance” and the “logic step”. It should be noted that the “distance (L)” of the analysis target path is defined as “a length of a diagonal line of a minimum rectangle that includes the analysis target path”, as shown in FIG. 2.

A commercially available major STA tool reads such the LOCV table and selects the OCV coefficient in consideration of the logic step and the distance of the analysis target path. The STA by the use of the LOCV table is described also in the following reference literature: Ayhan Mutlu et al., “A Parametric Approach for Handling Local Variation Effects in Timing Analysis,” DAC 2009.

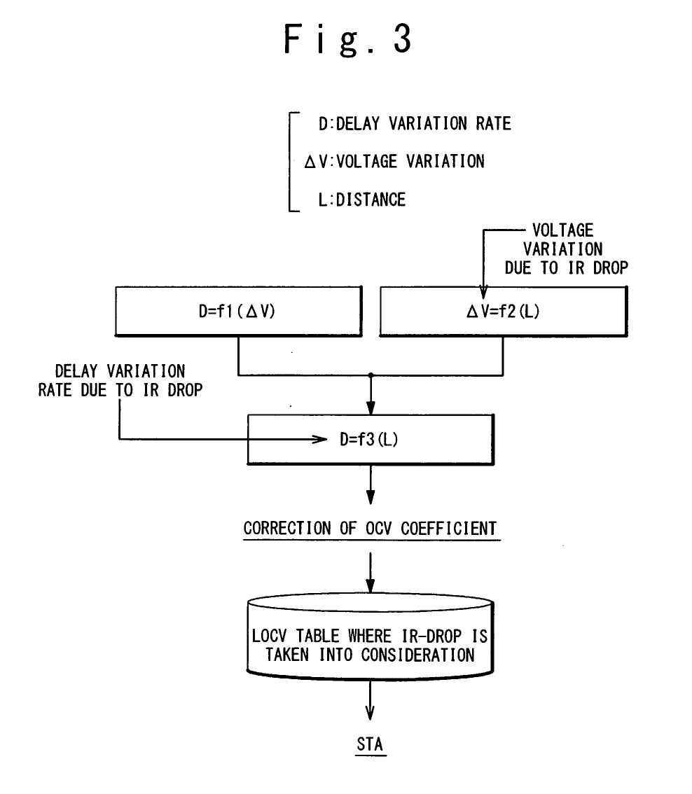

According to the present embodiment, influence of the IR drop on the delay value is taken into consideration in the STA. More specifically, the OCV coefficient that depends on the “distance (L)” is corrected in consideration of the influence of the IR drop. By using the post-correction OCV coefficient, it is possible to achieve the STA where the influence of the IR drop is taken into consideration. A summary of the present embodiment is described below with reference to FIG. 3.

First, a “delay-voltage function” that indicates a relationship between a delay variation rate D and voltage variation ΔV is calculated. The delay-voltage function is expressed by the following Equation (1).

D=f1(ΔV) Equation (1)

The delay-voltage function can be obtained through a circuit simulation.

Meanwhile, a “voltage-distance function” that indicates a relationship between the voltage variation ΔV due to the IR drop and the distance L is calculated. The voltage-distance function is expressed by the following Equation (2).

ΔV=f2(L) Equation (2)

The voltage-distance function can be obtained from a result of an IR drop analysis of the target circuit.

By combining the above-mentioned Equations (1) and (2), a “delay-distance function” that indicates a relationship between the delay variation rate D and the distance L can be calculated. The delay-distance function is expressed by the following Equation (3).

D=f3(L) Equation (3)

It should be noted here that the left-hand side of the Equation (3) represents the delay variation rate D due to the IR drop. That is, the delay variation rate D caused by the IR drop is expressed as a function of the distance L of the analysis target path.

By using the delay-distance function, each OCV coefficient in the LOCV table (see FIG. 1) is corrected. As a result, an LOCV table in which the influence of the IR drop is reflected is generated. In the STA, the LOCV table in which the influence of the IR drop is reflected is referred to, that is, the above-mentioned post-correction OCV coefficient is used. This enables high-precision STA where the influence of the IR drop is taken into consideration.

According to the present embodiment, as described above, the influence of the IR drop on the delay value is given as a function of the distance L. Then, by using the function, the influence of the IR drop is incorporated into the OCV coefficient that depends on the distance L. The influence of the IR drop is automatically taken into consideration by just using the OCV coefficient to perform the STA as usual. That is, a time required for the STA is not increased. Once the LOCV table is generated with respect to each technology, the STA can be repeated with ease. This leads to suppression of the design time.

Hereinafter, embodiments of the present invention will be described in more detail.

### 2. First Embodiment

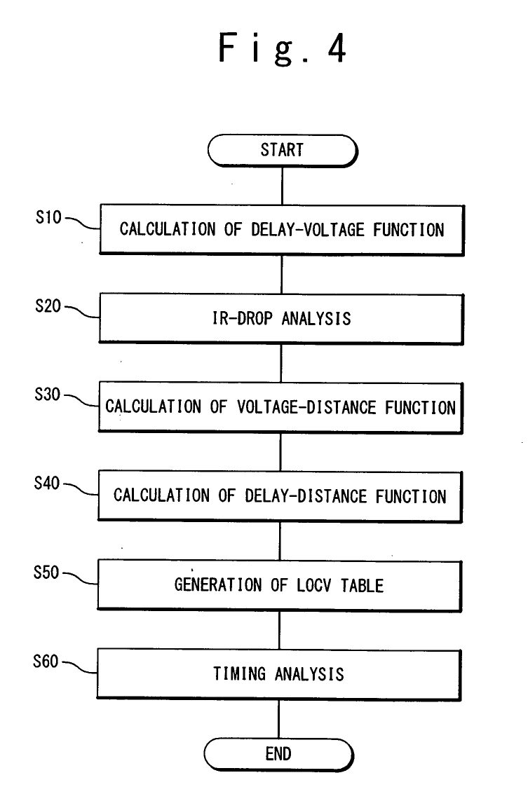

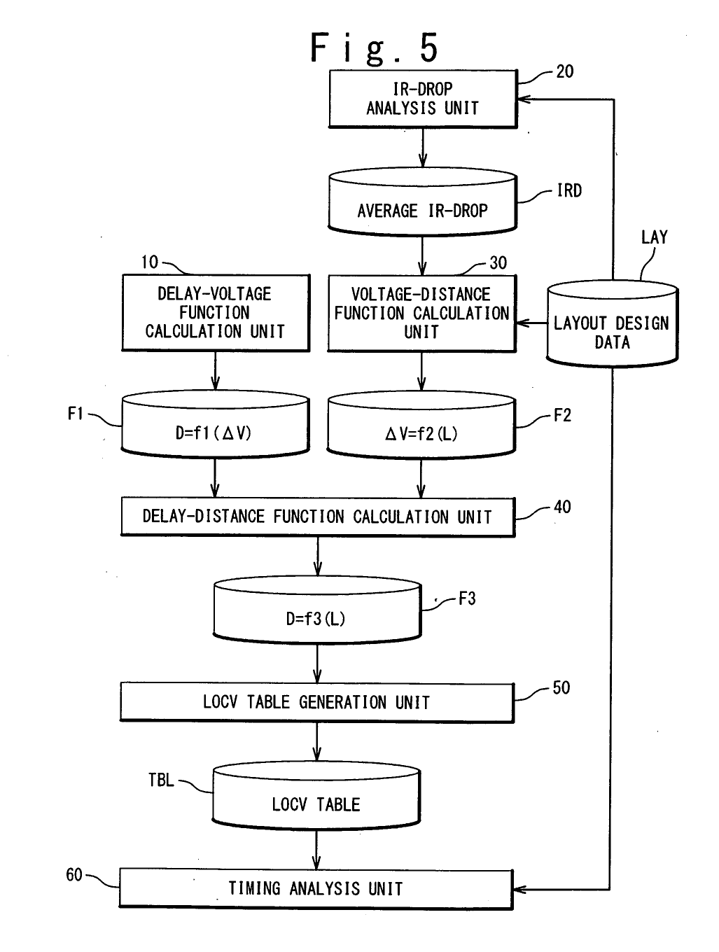

FIG. 4 is a flow chart showing a timing analysis method according to a first embodiment. FIG. 5 is a block diagram showing timing analysis processing according to the first embodiment. Processing of each Step will be described in detail by appropriately referring to FIGS. 4 and 5.

2-1. Step S10 (Calculation of Delay-Voltage Function)

A delay-voltage function calculation unit 10 performs a circuit simulation to calculate the delay-voltage function (D=f1 (ΔV)) expressed by the above Equation (1). This calculation is performed with respect to each unit in which the LOCV table is created (e.g. with respect to each technology, each cell type and the like).

More specifically, the delay-voltage function calculation unit 10 executes a circuit simulation with regard to a cell representative of the technology or the cell type to calculate a delay time of the cell. Here, the delay-voltage function calculation unit 10 uses two or more patterns as the power-supply voltage of the cell and calculates the delay times corresponding to the respective power-supply voltages. Based on the result, the delay-voltage function calculation unit 10 can calculate the delay-voltage function that indicates a relationship between the delay variation rate D and the voltage variation ΔV.

For example, the circuit simulation is executed with regard to a cell under respective conditions where the power-supply voltage is 2.0 V and 1.9 V. Let us consider a case where a delay time between an input signal and an output signal of the cell is calculated to be 4.0 nsec (in the case of 2.0 V) and 4.1 nsec (in the case of 1.9 V). In this case, the delay variation rate per unit voltage is calculated to be (4.0−4.1)/4.0/(2.0−1.9)=−0.25. Here, “the delay variation rate per unit voltage=−0.25” means that the delay time is increased by 25% of the delay time corresponding to an ideal power-supply voltage with every decrease in the power-supply voltage by 1 V. It should be noted that the calculation method is not limited to the present example where linearity between voltage and delay is assumed and linear approximation is performed based on respective delay times corresponding to two kinds of the power-supply voltage. It is also possible to measure delay times corresponding to three or more kinds of the power-supply voltage and approximate by using a second or more-order polynomial or an exponential.

The delay-voltage function calculation unit 10 generates a delay-voltage function data F1 indicating the delay-voltage function thus calculated and stores the delay-voltage function data F1 in a memory device.

2-2. Step S20 (IR Drop Analysis)

An IR drop analysis unit 20 performs a dynamic IR drop analysis of the target circuit by using a power-supply noise analysis tool to calculate a power-supply voltage waveform of an instance (circuit element) included in the target circuit. Here, the IR drop analysis unit 20 preferably selects plural (about 100) representative instances from instances included in the target circuit and then calculates a power-supply voltage waveform (and also a ground voltage waveform if needed) of each of the representative instances. Preferably, the representative instances are selected by reference to a layout design data LAY (e.g. DEF format) indicating a layout design of the target circuit. For example, the representative instances are selected such that their positions on a chip layout are distributed as uniform as possible. Alternatively, the representative instances may be selected randomly.

Subsequently, the IR drop analysis unit 20 calculates a time average of the power-supply voltage waveform that was calculated with respect to each representative instance (if the ground voltage also is taken into consideration, a time average of a voltage waveform obtained by subtracting the ground voltage waveform from the power-supply voltage waveform is calculated). A range in which the time average is calculated is, for example, one clock cycle of a principal clock line or a lowest frequency clock line within the target circuit. Then, the IR drop analysis unit 20 sets the calculated time average as an average IR drop of the representative instance. The IR drop analysis unit 20 generates an average IR drop data IRD indicating the average IR drop of each representative instance thus calculated and stores the average IR drop data IRD in the memory device.

It should be noted that if the dynamic IR drop analysis is hard to execute, the IR drop analysis unit 20 may calculate the IR drop of each representative instance by using a static IR drop analysis tool and set it as the average IR drop. The IR drop analysis may be performed with respect to each product type of the semiconductor integrated circuit or with respect to each technology.

2-3. Step S30 (Calculation of Voltage-Distance Function)

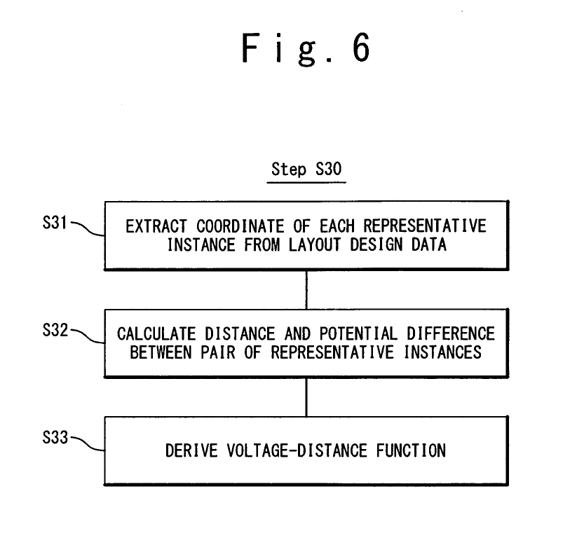

A voltage-distance function calculation unit 30 reads the average IR drop data IRD and the layout design data LAY from the memory device and calculates, based on the read data, the voltage-distance function (ΔV=f2 (L)) expressed by the above Equation (2). FIG. 6 is a flow chart showing processing in Step S30.

Step S31:

First, the voltage-distance function calculation unit 30 extracts coordinate information of each representative instance from the layout design data LAY (e.g. DEF format).

Step S32:

Next, the voltage-distance function calculation unit 30 considers “representative instance pairs” one by one. Here, a representative instance pair is a combination of arbitrary two representative instances out of the above-mentioned selected representative instances. The voltage-distance function calculation unit 30 calculates the “distance L” and the “potential difference ΔV” between the two representative instances with regard to each representative instance pair. The distance L between the two representative instances can be calculated based on the above-mentioned coordinate information extracted from the layout design data LAY. On the other hand, the potential difference ΔV (difference in the average IR drop) between the two representative instances can be calculated based on the above-mentioned average IR drop data IRD. Consequently, a list (distance-potential difference list 1) that indicates a correspondence relationship between the distance L and the potential difference ΔV (difference in the average IR drop) with regard to all the representative instance pairs is created.

Step S33:

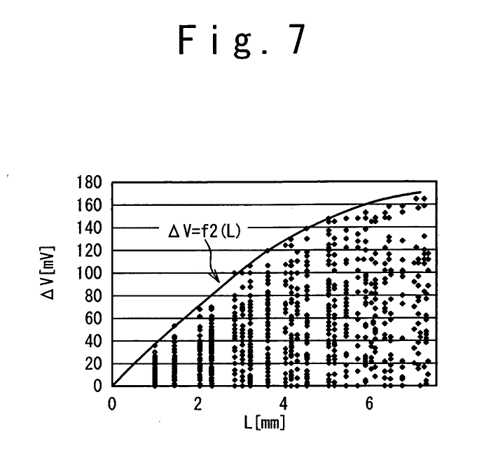

Lastly, the voltage-distance function calculation unit 30 derives the voltage-distance function (ΔV=f2 (L)) based on the list created in the above Step S32. That is, the voltage-distance function calculation unit 30 derives the voltage-distance function based on the correspondence relationship between the distance L and the potential difference ΔV (difference in the average IR drop) with regard to each representative instance pair which was obtained in the above Step S32. For example, the voltage-distance function is expressed by a multidimensional polynomial or an exponential. FIG. 7 conceptually shows the derived voltage-distance function.

An example of deriving the voltage-distance function is described below. The above-mentioned distance-potential difference list 1 is sorted in ascending order of the distance, and thereby a distance-potential difference list 2 is obtained. Distance ranges such as from 0 to 0.1 mm, from 0.1 mm to 0.2 mm, from 0.2 to 0.3 and the like are determined. The above-mentioned distance-potential difference list 2 is investigated, and an instance pair whose potential difference is maximum is selected with respect to each of the distance ranges. Data of each distance range, i.e. data of the distance and the potential difference regarding the each selected instance pair is added to a distance-potential difference list 3 (in an initial state, this list 3 includes only a data of distance 0 and potential difference 0). If no instance pair exists within a distance range, data of the distance range is not added to the distance-potential difference list 3. Next, the distances and the potential differences in the distance-potential difference list 3 are plotted on a two-dimensional xy plane. A part of the plotted points are deleted such that a sequence of line segments which is obtained by connecting the remaining points one after another in an order of the list forms a part of convex polygon. The remaining points are approximated by a quadratic expression through a least squares method or the like.

The voltage-distance function calculation unit 30 generates a voltage-distance function data F2 indicating the voltage-distance function thus calculated and stores the voltage-distance function data F2 in the memory device.

2-4. Step S40 (Calculation of Delay-Distance Function)

A delay-distance function calculation unit 40 reads the delay-voltage function data F1 and the voltage-distance function data F2 from the memory device. Then, the delay-distance function calculation unit 40 combines the delay-voltage function (D=f1 (LV)) and the voltage-distance function (ΔV=f2 (L)) to calculate the delay-distance function (D=f3 (L)) expressed by the above Equation (3).

For example, let us consider the following situation.

delay-voltage function:D=f1(ΔV)=rΔV

voltage-distance function:ΔV=f2(L)=aL²+bL+c
r, a, b and c: coefficients

In this case, the delay-distance function is calculated as follows.

delay-distance function:D=f3(L)=r×(aL²+bL+c)

The D on the left-hand side of this equation represents the delay variation rate due to the IR drop.

The delay-distance function calculation unit 40 generates a delay-distance function data F3 indicating the delay-distance function thus calculated and stores the delay-distance function data F3 in the memory device.

2-5. Step S50 (Generation of LOCV Table)

An LOCV table generation unit 50 generates the LOCV table TBL. Here, the LOCV table generation unit 50 reads the delay-distance function data F3 from the memory device and uses the delay-distance function (D=f3 (L)) to correct the OCV coefficient that depends on the distance L. As a result, the LOCV table TBL in which influence of the IR drop is reflected is generated.

For example, the LOCV table generation unit 50 first calculates a usual OCV coefficient associated with a random component and a systematic component of process variability as usual (refer to Japanese Patent Publication JP-2007-323673, for example) to generate a usual LOCV table (see FIG. 1). Subsequently, the LOCV table generation unit 50 multiplies an OCV coefficient applied to a capture path (see FIG. 2) in a hold analysis by a correction coefficient “1+D”. Also, the LOCV table generation unit 50 multiplies an OCV coefficient applied to the capture path in a setup analysis by a correction coefficient “1-D”. Alternatively, the LOCV table generation unit 50 multiplies an OCV coefficient applied to a launch path (see FIG. 2) in a hold analysis by a correction coefficient “1-D” and multiplies an OCV coefficient applied to the launch path in a setup analysis by a correction coefficient “1+D”. In this manner, the influence of the IR drop is taken into consideration.

It should be noted that the LOCV table TBL is generated with respect to each technology and with respect to each cell type. The generated LOCV table TBL is stored in the memory device.

2-6. Step S60 (Timing Analysis)

A timing analysis unit 60 uses an STA tool, the layout design data LAY and the LOCV table TBL to execute the STA in the same manner as the conventional one. Even by the same manner as the conventional one, it is possible to achieve high-precision STA where the influence of the IR drop is taken into consideration, because the influence of the IR drop is already reflected in the LOCV table TBL.

2-7. Effects

According to the present embodiment, as described above, the influence of the IR drop on the delay value is given as a function of the distance L. Then, by using the function, the influence of the IR drop is incorporated into the OCV coefficient that depends on the distance L. The influence of the IR drop is automatically taken into consideration by just using the OCV coefficient to perform the STA as usual. That is, a time required for the STA is not increased. Once the LOCV table is generated with respect to each technology, the STA can be repeated with ease. This leads to suppression of the design time.

Moreover, according to the present embodiment, the influence of the IR drop on the delay value is “properly” taken into consideration. As a comparative example, let us consider a case where the influence of the IR drop is considered in the STA without using the LOCV table TBL of the present embodiment. In this case where no policy is provided, it is necessary to assume a most pessimistic situation where a maximum IR drop occurs on one of the launch path and the capture path while no IR drop occurs on the other of them. However, to assume unnecessarily pessimistic situation causes increase in the number of times of starting over the design processing again, increase in a design margin, increase in a chip area, decrease in a circuit operating frequency and the like, which is not desirable. Whereas, in the present embodiment, the OCV coefficient is corrected based on the delay-distance function and thus the influence of the IR drop is properly taken into consideration. Therefore, the number of times of starting over the design processing is decreased and the design time is reduced. Furthermore, since the design margin is decreased, the chip area is reduced and the circuit operating frequency is improved.

The generating the LOCV table TBL according to the present embodiment just needs to be performed once with respect to each technology, which has little effect on the design time. Moreover, a processing time required for generating the LOCV table TBL has practically no effect on the design time. The Step S10, which is usual processing, does not increase the processing time. The processing of Steps S20 and $30 is performed not for all the instances but only for a limited number of representative instances (about 100 representative instances). Therefore, a processing time and a memory capacity required for the processing have practically no effect. The processing of Step S40, which is just substituting of a function, has little effect on the processing time. The processing of Step S50, which can be easily achieved by using the delay-distance function, has little effect on the processing time. It should be noted the generating the LOCV table TBL just needs to be performed once with respect to each technology. However, the generating the LOCV table TBL may be performed with respect to each product type in order to improve precision.

As described above, the method according to the present embodiment has little effect on the processing time, the design time and computational resources. It is therefore possible to easily incorporate the method according to the present embodiment into an existing design flow.

### 3. Second Embodiment

The IR drop may not be uniform on a layout plane. There may be a region where the IR drop is comparatively strong as well as a region where the IR drop is comparatively weak. Therefore, according to a second embodiment, a layout plane is divided and the correction of the OCV coefficient is performed with respect to each division region, in order to improve precision.

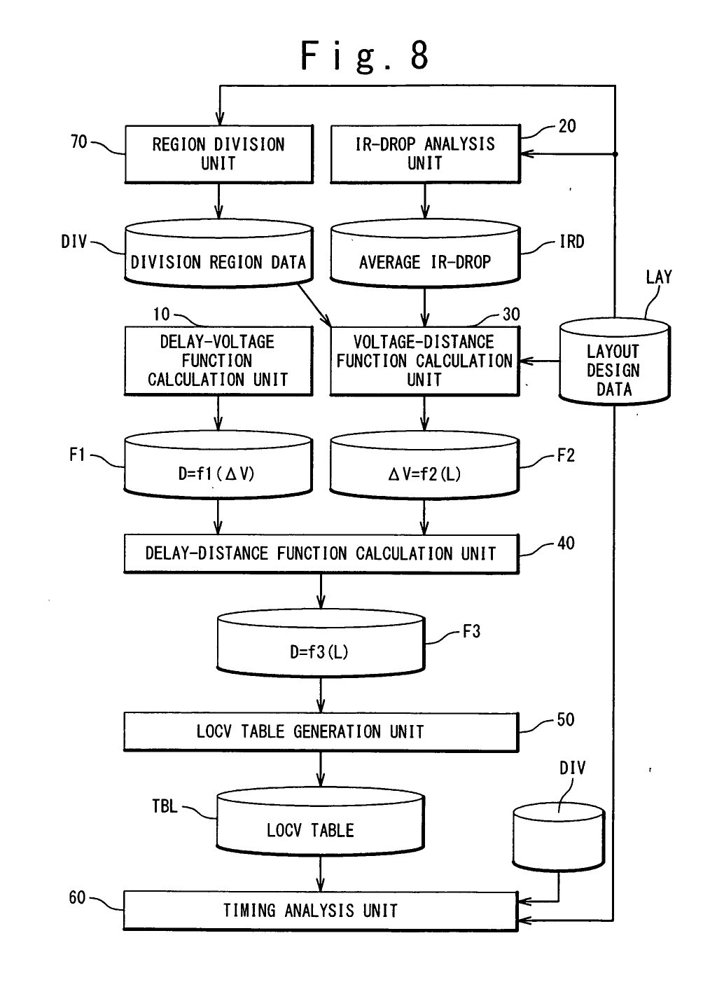

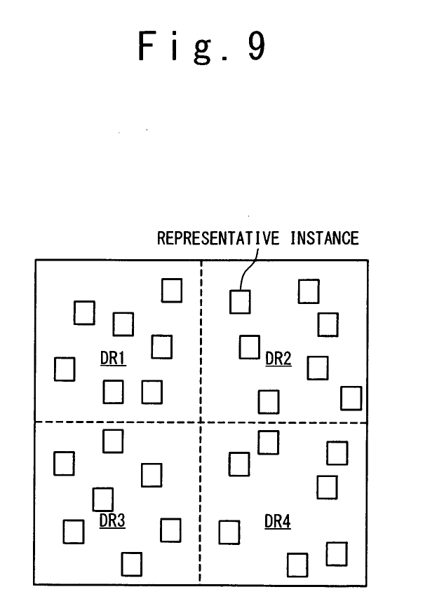

FIG. 8 is a block diagram showing timing analysis processing according to the second embodiment. An overlapping description with the first embodiment will be omitted as appropriate. According to the second embodiment, a region division unit 70 is added to the configuration in the first embodiment. The region division unit 70 refers to the layout design data LAY and divides a layout region of the target circuit into a plurality of division regions DR as shown in FIG. 9. In the example shown in FIG. 9, the layout region is divided into four division regions DR1 to DR4 on the left, right, top and bottom. The region division unit 70 generates a division region data DIV indicating the respective division regions and stores the division region data DIV in the memory device.

In the Step S30, the voltage-distance function calculation unit 30 refers to the division region data DIV and performs the processing with respect to each division region DR. As a result, the voltage-distance function data F2 is generated with respect to each division region DR. In the Step S40, the delay-distance function calculation unit 40 uses the voltage-distance function data F2 generated with respect to each division region DR to generate the delay-distance function data F3 with respect to each division region. In the Step S50, the LOCV table generation unit 50 uses the delay-distance function data F3 generated with respect to each division region to generate the LOCV table TBL with respect to each division region.

In the Step S60, the timing analysis unit 60 executes the STA. Here, the timing analysis unit 60 refers also to the division region data DIV and uses the OCV coefficient described in an LOCV table TBL with respect to a division region DR including an analysis target path. For example, if the analysis target path is included in the division region DR1, the OCV coefficient described in the LOCV table TBL associated with the division region DR1 is used. If the analysis target path lies over a plurality of division regions DR, the most pessimistic OCV coefficient (the OCV coefficient whose difference from 1 is largest) is adopted. For example, in a case where the analysis target path lies over the division regions DR1 and DR2, the LOCV table TBL associated with the division region DR1 gives the OCV coefficient=1.1 and the LOCV table TBL associated with the division region DR2 gives the OCV coefficient=1.2, the timing analysis unit 60 adopts the OCV coefficient=1.2 and applies it to the analysis target path.

According to the present embodiment, the OCV coefficient associated with the division region DR is used in the STA. Therefore, in a case where magnitude of the IR drop is not uniform on the layout region, the precision of the STA considering the IR drop is improved. Moreover, the design margin is decreased, which is preferable. It should be noted in the present embodiment that the Steps S20 to S50 are performed with respect to each product type of the semiconductor integrated circuit.

### 4. Timing Analysis System

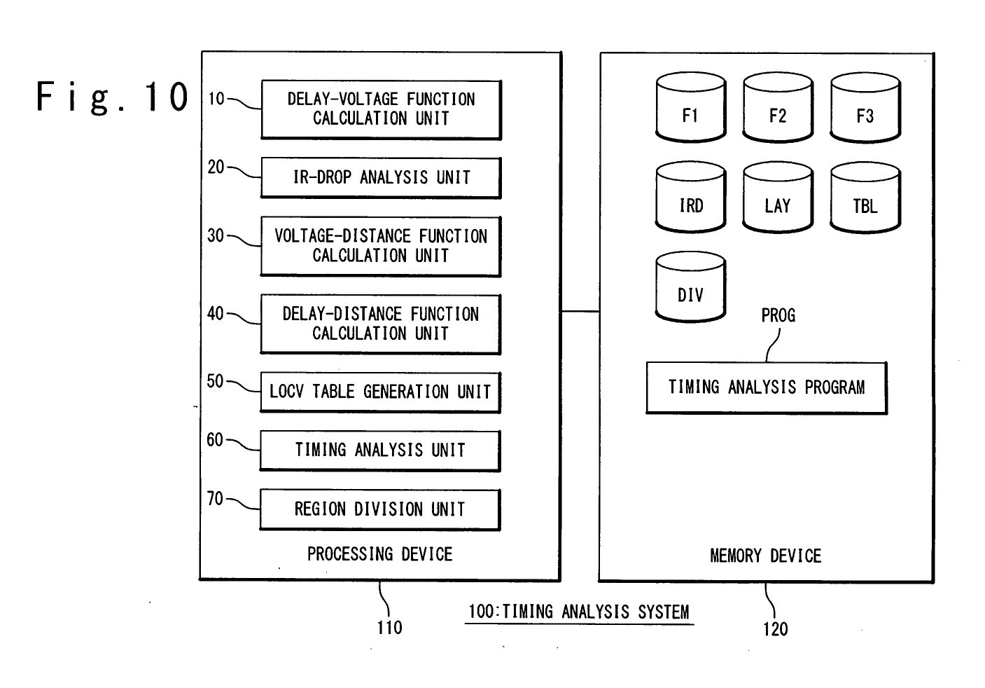

FIG. 10 is a block diagram showing a configuration of a timing analysis system 100 according to the embodiment of the present invention. The timing analysis system 100 is a computer system that achieves the timing analysis processing according to the present invention. Specifically, the timing analysis system 100 has a processing device 110 and a memory device 120. The processing device 110 includes a CPU (Central Processing Unit). The memory device 120 includes a RAM (Random Access Memory) and a HDD (Hard Disk Drive).

Stored in the memory device 120 are various data such as the delay-voltage function data F1, the voltage-distance function data F2, the delay-distance function data F3, the average IR drop data IRD, the layout design data LAY, the LOCV table TBL and the division region data DIV mentioned above.

The processing device 110 has various functional blocks such as the delay-voltage function calculation unit 10, the IR drop analysis unit 20, the voltage-distance function calculation unit 30, the delay-distance function calculation unit 40, the LOCV table generation unit 50, the timing analysis unit 60 and the region division unit 70 mentioned above. The functional blocks read necessary data from the memory device 120 and execute the above-described processing.

Each of the functional blocks of the processing device 110 can be achieved by the processing device 110 executing a timing analysis program FROG. The timing analysis program PROG is a computer program which causes a computer (processing device 110) to perform the timing analysis processing according to the present invention. The timing analysis program PROG is stored in the memory device 120, and is read and executed by the processing device 110. Moreover, the timing analysis program PROG may be recorded on a tangible computer-readable recording medium.

While the exemplary embodiments of the present invention have been described above with reference to the attached drawings, the present invention is not limited to these exemplary embodiments and can be modified as appropriate by those skilled in the art without departing from the spirit and scope of the present invention.

What is claimed is:

1. A timing analysis method comprising:
calculating a delay-voltage function that indicates a relationship between a delay variation rate and voltage variation;
calculating a voltage-distance function that indicates a relationship between said voltage variation due to IR drop and a distance;
calculating, by combining said delay-voltage function and said voltage-distance function, a delay-distance function that indicates a relationship between said delay variation rate due to IR drop and said distance;
correcting, by using said delay-distance function, an OCV coefficient that depends on said distance; and
executing a timing analysis of a target circuit by using said post-correction OCV coefficient.

2. The timing analysis method according to claim 1,
wherein said target circuit includes a plurality of representative instances, and arbitrary two of said plurality of representative instances are a representative instance pair,
wherein said calculating said voltage-distance function comprises:
calculating, by reference to a layout design data indicating a layout design of said target circuit, a distance between said two representative instances of each representative instance pair;
calculating, by reference to an average IR drop data indicating average IR drop of each of said plurality of representative instances, a potential difference between said two representative instances of each representative instance pair; and
determining said voltage-distance function based on said distance and said potential difference calculated with respect to said each representative instance pair.

3. The timing analysis method according to claim 2,
further comprising: generating said average IR drop data,
wherein said generating said average IR drop data comprises:
selecting said plurality of representative instances from instances included in said target circuit;
performing an IR drop analysis of said target circuit to calculate a power-supply voltage waveform of each of said plurality of representative instances; and
calculating, as said average IR drop of said each representative instance, a time average of said power-supply voltage waveform calculated with respect to said each representative instance.

4. The timing analysis method according to claim 1,
further comprising: dividing a layout region of said target circuit into a plurality of division regions,
wherein said calculating said voltage-distance function, said calculating said delay-distance function and correcting said OCV coefficient are performed with respect to each of said plurality of division regions,
wherein in said executing the timing analysis of said target circuit, said post-correction OCV coefficient with respect to a division region including a target path is used.

5. A timing analysis program recorded on a tangible computer-readable medium that, when executed, causes a computer to perform timing analysis processing,
said timing analysis processing comprising:
calculating a delay-voltage function that indicates a relationship between a delay variation rate and voltage variation;
calculating a voltage-distance function that indicates a relationship between said voltage variation due to IR drop and a distance;
calculating, by combining said delay-voltage function and said voltage-distance function, a delay-distance function that indicates a relationship between said delay variation rate due to IR drop and said distance;
correcting, by using said delay-distance function, an OCV coefficient that depends on said distance; and
executing a timing analysis of a target circuit by using said post-correction OCV coefficient.

6. A timing analysis system comprising:
a delay-voltage function calculation unit configured to calculate a delay-voltage function that indicates a relationship between a delay variation rate and voltage variation;
a voltage-distance function calculation unit configured to calculate a voltage-distance function that indicates a relationship between said voltage variation due to IR drop and a distance;
a delay-distance function calculation unit configured to calculate, by combining said delay-voltage function and said voltage-distance function, a delay-distance function that indicates a relationship between said delay variation rate due to IR drop and said distance;
a table generation unit configured to correct, by using said delay-distance function, an OCV coefficient that depends on said distance; and
a timing analysis unit configured to execute a timing analysis of a target circuit by using said post-correction OCV coefficient.
